(19) United States
(12) Patent Application Publication
(10) Pub. No.: US 2023/0151224 A1
(43) Pub. Date: May 18, 2023

(54) MICROBIAL REDUCTION COATING COMPOSITIONS AND METHODS OF USE THEREOF

(71) Applicant: UNIVERSITY OF HOUSTON SYSTEM, Houston, TX (US)

(72) Inventors: Seamus Curran, Houston, TX (US); Kang-Shyang Liao, Houston, TX (US); Surendra Maharjan, Houston, TX (US); Alexander Wang, Houston, TX (US); Eileen Mellon, Houston, TX (US)

(73) Assignee: UNIVERSITY OF HOUSTON SYSTEM, Houston, TX (US)

(21) Appl. No.: 17/913,963

(22) PCT Filed: Mar. 24, 2021
(86) PCT No.: PCT/US2021/023866

§ 371 Date: Sep. 23, 2022

Related U.S. Application Data
(60) Provisional application No. 62/994,167, filed on Mar. 24, 2020.
(60) Provisional application No. 63/016,493, filed on Apr. 28, 2020.

(51) Int. Cl. C09D 5/14; C09D 7/63; C09D 183/08; C09D 183/02; C09D 5/16

(52) U.S. Cl. CPC C09D 5/14; C09D 5/1625; C09D 7/63; C09D 183/02; C09D 183/08

(57) ABSTRACT

In an embodiment, the present disclosure pertains to a method of coating a substrate to impart antiviral and water resistance to the substrate. In general, the method includes obtaining a substrate and applying a coating composition to the substrate. In some embodiments, the coating composition imparts antiviral and water resistance properties to the substrate. In some embodiments, the coating composition has an antiviral method of action against a virus by causing damage to at least one of a capsid of the virus, an outer envelope of a protein layer of the virus, a spike protein of the virus, a cellular membrane of the virus, or combinations thereof.

### CROSS-REFERENCE TO RELATED APPLICATIONS

This patent application claims priority from, and incorporates by reference the entire disclosure of, U.S. Provisional Pat. Application No. 62/994,167 filed on Mar. 24, 2020 and U.S. Provisional Pat. Application No. 63/016,493 filed on Mar. 28, 2020.

### TECHNICAL FIELD

The present disclosure relates generally to coating compositions and more particularly, but not by way of limitation, to microbial (e.g., viral or bacterial) reduction coating compositions and methods of use thereof.

### BACKGROUND

This section provides background information to facilitate a better understanding of the various aspects of the disclosure. It should be understood that the statements in this section of this document are to be read in this light, and not as admissions of prior art.

Much effort has been directed to solving the problem of imparting resistance and/or inhibition against microbes, such as, but not limited to, infectious viral, bacterial, or fungal diseases, for example, coronavirus disease 2019 (COVID-19), Middle East respiratory syndrome (MERS), severe acute respiratory syndrome (SARS), or severe acute respiratory syndrome-related coronavirus (SARSR-COV), to fabrics, textiles, fibers, garments, filters, plastics, porous substrates, and tarps-based products, including, but not limited to, tarpaulin-type materials. While the use of melt blown fabrics are somewhat effective in preventing the transmission of infectious microbes, such as viruses, after use these fabrics must be disposed of carefully, as quite often the infectious agent is still alive and potentially still infectious, transmissible, and capable of cross contamination. These materials do not deactivate and/or kill the microbes (e.g., viruses/bacteria), but instead act merely as a physical barrier. The infectious nature of various microbes, such as, viruses and bacteria (i.e., infections agents/diseases/contagions), means any surface contaminated by the microbes potentially becomes an active incubation site for the microbe.

Current methods to mitigate the transmission of infectious agents/diseases in hospitals, homes, schools, apartments, offices, public spaces (including all germane surfaces), personal protective equipment (PPE), such as masks, gowns, gloves and other various clothing items, means in such shared or non-exclusive areas, require vigorous and frequent treatments (e.g., hourly or daily treatment) with antimicrobials, for example, antivirals or anti-infectious agents. These can include, for example, surface cleaners, using some form of detergent, an alcohol solution with at least 70% alcohol, and household disinfectants (e.g., benzalkonium chlorides or alkyl ammonium chlorides), bleach, peroxides, sodium hypochlorite, chlorine dioxide, and combinations of the same and like.

When dealing with fabrics after their exposure to infectious agents such as, but not limited to, severe acute respiratory syndrome coronavirus 2 (SARS-CoV-2), it is common practice to wash the fabric(s) in near boiling or boiling water in an effort to kill the virus. When possible, it is an additional precaution to use antiviral soaps and detergents with the fabrics. If the fabrics cannot be washed immediately, generally, they should be disposed of immediately, and in fact, this is quite often the case for most PPE. However, cross contamination between fabrics, material surfaces, and even health care personnel can occur as the microbes have inhabited the pores of the materials, and thus, the infectious agents and/or pathogens remain transmittable. In addition, once washed, the fabrics must additionally be thoroughly dried.

When around others or in regions where the microbes, such as infectious agent(s)/contagion(s) may have traveled, it is best to wear PPE to provide protection against the microbes, to mitigate transmission or cross contamination of the microbes, such as infection agent(s)/contagion(s). Standard practices regarding PPE in healthcare environments entail the use of disposable gloves and gowns that need to be taken off immediately after use for disposal. While there are multiple reasons for this, the principle factor is the risk of contaminated PPE containing infectious agent(s)/contagion(s) cross contaminating other surfaces and/or facilitating transmission. In addition, if there are any breaches in the PPE (e.g., holes, tears, exposure through poor fitting PPE, or failure of the protective membranes of the PPE), this can also lead to dire circumstances which can lead to cross contamination of microbes, such as infectious agent(s)/contagion(s). These breaches have to be reported, and the person who has been exposed must then be examined carefully for potential transition from the caregiver to another patient or similar transmissions. For cross contamination or accelerated transmission to occur, microbes such as viruses need to breach the protective measure(s) that are in place. To prevent that from happening, surfaces and personnel need to be protected, and interactions carefully managed, which is often a very difficult task.

Even when surfaces are treated with some form of antimicrobial or disinfectant to prevent transmission or cross contamination of infectious agents or viruses, such as, for example SARS-CoV-2, these treatments usually involve short-term solutions, such as immediate disinfection with irradiation, as opposed to something that is far more long-term or permanent. Unless the treatment is permanently locked in place, locked in place for longer than, for example, 12 hours, or immobilized, due to the nature of certain microbes being non-water soluble and resistant to chemical cleaners, the various microbes, such infectious agent(s)/contagion(s), can remain active and potentially cross contaminate other surfaces or transmit to a host. Fabrics not only require a water repellent, as the medium by which many infectious agent(s) travel is largely aqueous, but also an active compound(s) to deactivate, lyse, and/or eradicate any infectious agent(s) or contaminant(s) that comes into contact with the fabric surface before it becomes a transmissible contagion. While such protective measures are critical for decreasing transmission of microbes, such as infectious agent(s)/contagion(s), current chemical treatments do not provide such a solution.

Furthermore, instead of using water-based treatment solutions, the use of carrier solvents, such as alcohols, serve duel purposes, as they act as carrier agents for sol-gel systems and quaternary ammonium compounds (QACs), for example, and act as a disinfecting agent when applied to a surface by sterilizing the surface of unwanted microbes (e.g., bacteria and viruses) before the sol becomes fully cured through a crosslinking process.

Surfaces can be treated with various solutions to prevent water from “wetting” a substrate of the surface, and thus becomes “waterproof”, and protect the substrate from consequences caused by wetting, such as, for example, staining from dyes or pigments, or water damage. While these solutions can have various benefits, the solutions to treat various surfaces and/or materials can be further improved to include one or more functional additives that can add further benefits to the resulting hydrophobic coating, such as, for example, functional additives to alleviate damage from weathering caused by both natural and artificial radiation, provide antifungal properties, provide antibacterial properties, and combinations of the same and like. The coatings can, for example, penetrate porous substrates, be layered on tarpaulin-type materials, or be bonded to fibers, such as those used in fabrics/textiles, and impart the surface(s) of the of the coated substrate with active compound(s) that cause damage to capsids or outer envelopes of a protein layer, spikes on a protein, or provide a process that could eventually lead to forms of viral/bacterial de-activation or lysis. In particular, hydrophobic coating composition(s) can be used to treat substrates to inhibit microbe contamination, such as, for example, viral or bacterial contamination, and prevent transmittal from various interactions, such as human-to-human, animal-to-human (e.g., zoonotic diseases or zoonosis), or human-to-animal, or via surface contact or deposition onto surfaces, fabrics, and other porous substrates that are shared to any extent, for example, various substrates that may come into contact with more than one human, animal, and combinations thereof. Various embodiments of the present disclosure seek to address the aforementioned needs, and provide the advantages as outlined above

### SUMMARY OF THE INVENTION

This summary is provided to introduce a selection of concepts that are further described below in the Detailed Description. This summary is not intended to identify key or essential features of the claimed subject matter, nor is it to be used as an aid in limiting the scope of the claimed subject matter.

In an embodiment, the present disclosure pertains to a method of coating a substrate to impart antiviral and water resistance to the substrate. In general, the method includes obtaining a substrate and applying a coating composition to the substrate.

In some embodiments, the coating composition imparts antiviral and water resistance properties to the substrate. In some embodiments, the coating composition has an antiviral method of action against a virus by causing damage to at least one of a capsid of the virus, an outer envelope of a protein layer of the virus, a spike protein of the virus, a cellular membrane of the virus, or combinations thereof.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described.

The present disclosure seeks to address the problems associated with addition of active compound(s), in particular, quaternary ammonium/phosphonium compound(s), tertiary sulfonium compound(s), or derivative(s) of such to a substrate. The premise of the present disclosure lies in the ability to functionalize and/or impregnate the substrate with a low-dimensional coating composition that includes active compound(s) of the present disclosure, in addition to coating the surface of the substrate. The active compound(s) can be quaternary ammonium/phosphonium compound(s), tertiary sulfonium compound(s), or derivative(s) of such, and the coating composition can provide protection against transmission of microbes, including, but not limited to, infectious diseases from bacteria or viruses, such as COVID-causing viruses (e.g., severe acute respiratory syndrome coronavirus 2 (SARS-CoV-2) or Middle East respiratory syndrome (MERS)), or other infectious agent(s)/contagion(s). After drying/curing, the compounds used for the coating form an effective hydrophobic layer and thus provide resistance against leaching of the quaternary ammonium/phosphonium compound(s), tertiary sulfonium compound(s), or derivative(s) of such from substrates by water through washing or exposure to exterior environments. The coating composition in general is hydrophobic and is suitable for treating/coating/impregnating porous substrates, functionalizing porous plastics, layering on tarpaulin, or coating/functionalizing synthetic/organic fibers, such as those used in manufacturing fabric, linens, garments, and masks, fiber materials used for manufacturing air filters (e.g., for heating, ventilation, and air conditioning systems), masonry materials, or aquatic structures. Without being bound by theory, it is believed that the components of the coating composition act as a carrier for the quaternary ammonium/phosphonium compound(s), tertiary sulfonium compound(s), or derivative(s) of such, which enables deposition of the quaternary ammonium/phosphonium compound(s), sulfonium compound(s), or derivative(s) of such on the outer and/or inner surface of the substrate. The carrier can be a solution of sol, sol-gel, or hydrophobic chemical agent(s). It is further believed that the active compound(s) (e.g., quaternary ammonium/phosphonium compound(s) or derivative(s) of such) can chemically react with the, sol, sol-gel, or hydrophobic chemical agent(s) (e.g., formation of a covalent bond) and/or be physically encapsulated in the sol, sol-gel, or a covalent network provided by the hydrophobic chemical agent(s).

The present disclosure can also provide an effective, breathable, penetrating, virucidal/bactericidal coating which exhibits broad-spectrum virucidal and bactericidal properties via a simple coating process that prevents/reduces premature leaching of active compound(s) to maintain long-term inhibition against microbes, such as infectious agents/contagions. Viral or bacterial resistance/inhibition/deactivation may be achieved via the inclusion of one or more species of quaternary ammonium/phosphonium compound(s) or tertiary sulfonium compound(s) that are either target-specific or more general in the particular mechanism of action by which they inhibit, deactivate, and/or lyse infectious agent(s)/contagion(s). In consideration of the diversity in certain families of viral/bacterial species, the specific mechanism of action by which the effectiveness of the protein in spreading the viruses is inhibited. For example, in coronaviruses, the outer proteins carry out a number of steps, which include standard packaging of the viral RNA, as well as helping the viral RNA link up with its replicating enzymes. In particular, by disrupting the protein structure on contact with cationic virucidal agents, the coating inhibits the reproducibility and mainly the survivability of infectious viral agents/contagions on the protected surface/substrate.

Embodiments of the disclosure relate to compositions and methods for making coating compositions for substrates. In one particular aspect of the present disclosure, a hydrophobic coating composition capable of inhibiting/reduction the transmission of infectious diseases such as coronavirus diseases (COVID), and other SARS-CoV causing diseases, is described. The hydrophobic coating composition can include at least one active compound (e.g., a quaternary ammonium/phosphonium compound, tertiary sulfonium compound, or derivative(s) of such), at least one hydrophobic chemical agent, and at least one solvent. In some embodiments, the composition may also include one or more base compounds, bonding agents, plasticizers, and other functional additives.

The coating compositions of the present disclosure are capable of depositing the active compound(s) to an inner surface of the substrate (e.g., such that the active compound(s) permeate the substrate). In a particular aspect of the present disclosure, the quaternary ammonium/phosphonium compound(s), or derivative(s) of such, can include a quaternary ammonium/phosphonium cation, which includes a positively charged polyatomic ion with the structure (QR₄)⁺ (Q being either a nitrogen or phosphorous atom and R being an aryl, alkyl, phenyl, benzyl, allyl, alkenyl, or alkynyl group, and that the ammonium/phosphonium cations are permanently charged regardless of the pH environment they exist in). Silyl ether, alkoxysilyl, hydroxysilyl, and silyl halide quaternary ammonium/phosphonium silanes can have a general formula of:

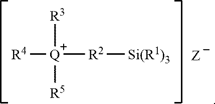

In various embodiments, Q is either a nitrogen atom or phosphorous atom, R¹ is an alkoxy group, hydroxyl group, halogen, hydrogen, or an alkyl group, or any combination thereof that includes at least one alkoxy/hydroxyl group. R², R³, R⁴, R⁵ are each independently hydrocarbon moieties having between 1 to 30 carbon atoms, a phenyl group, a benzyl group, a substituted alkyl group, an unsubstituted alkyl group, a substituted alkenyl group, an unsubstituted alkenyl group, a substituted alkynyl group, an unsubstituted alkynyl group, a substituted aryl group, or an unsubstituted aryl group, a substituted allyl group, an unsubstituted allyl group, or derivatives thereof. Z is an anionic atom or compound, or a halogen.

In a particular aspect, the silyl ether/trialkoxysilyl/trihydroxysilyl quaternary ammonium/phosphonium compounds can have a general formula of:

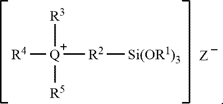

In various embodiments, Q is either a nitrogen atom or phosphorous atom, R¹ is hydrogen, methyl, ethyl, propyl, isopropyl, butyl, or isobutyl group or a combination thereof; R², R³, R⁴, R⁵ are each independently hydrocarbon moieties having between 1 to 30 carbon atoms, a phenyl group, a benzyl group, a substituted alkyl group, an unsubstituted alkyl group, a substituted alkenyl group, an unsubstituted alkenyl group, a substituted alkynyl group, an unsubstituted alkynyl group, a substituted aryl group, or an unsubstituted aryl group, a substituted allyl group, an unsubstituted allyl group, or derivatives thereof, and Z is an anionic atom or compound, or a halogen. Examples of quaternary ammonium organosilanes used in the present disclosure may include, but are not limited to, DIMETHYLOCTADECYL[(3-TRIHYDROXYSILYL)PROPYL] AMMONIUM CHLORIDE (CAS#: 199111-50-7), DIMETHYLOCTADECYL[(3-TRIMETHOXYSILYL)PROPYL] AMMONIUM CHLORIDE (CAS#: 27668-52-6), 3-(TRIMETHOXYSILYL)PROPYL-N,N,N-TRIMETHYLAMMONIUM CHLORIDE (CAS#: 35141-36-7), TETRADECYLDIMETHYL(3-TRIMETHOXYSILYLPROPYL)AMMONIUM CHLORIDE, N,N-DIDECYL-N-METHYL-N-(3-TRIMETHOXYSILYLPROPYL) AMMONIUM CHLORIDE (CAS#: 68959-20-6), OCTADECYLBIS (TRIETHOXYSILYLPROPYL) AMMONIUM CHLORIDE, 3-(N-STYRYLMETHYL-2-AMINOETHYLAMINO)PROPYLTRIMETHOXYSILANE HYDROCHLORIDE (CAS#: 34937-00-3), S-(TRIMETHOXYSILYLPROPYL) ISOTHIOURONIUM CHLORIDE (CAS#: 84682-36-0), N-(2-N-BENZYLAMINOETHYL)-3-AMINOPROPYLTRIMETHOXYSILANE HYDROCHLORIDE (CAS#: 623938-90-9), TETRADECYLDIMETHYL(3-TRIMETHOXYSILYLPROPYL)AMMONIUM CHLORIDE (CAS#: 41591-87-1) and 4-(TRIMETHOXYSILYLETHYL)BENZYLTRIMETHYL AMMONIUM CHLORIDE.

In a non-limiting example, the quaternary phosphonium organosilanes described and utilized in the current disclosure may be formed via reaction of a nucleophilic phosphine-functional compound (e.g., TRIPHENYLPHOSPHINE (CAS#: 603-35-0) or DICYCLOHEXYL[2,4,6-TRIS(1-METHYLETHYL)PHENYL]PHOSPHINE (CAS#: 303111-96-9)) with an electrophilic halogen-functional organosilane (e.g., 3-CHLOROPROPYLTRIMETHOXYSILANE (CAS#: 2530-87-2) or ((CHLOROMETHYL)PHENYLETHYL)TRIMETHOXYSILANE (CAS#: 68128-25-6)) via S_{N}2-type nucleophilic substitution to form a quaternary phosphonium organosilane with a cationic phosphonium group stabilized with the anionic halogen leaving group from the halogen-functional organosilane. In another non-limiting example, the quaternary phosphonium organosilanes described and utilized in the current disclosure may be formed via reaction of a nucleophilic phosphine-functional organosilane (e.g., 2-(DIPHENYLPHOSPHINO) ETHYLTRIETHXOYSILANE (CAS#: 18586-39-5), 3-(DIPHENYLPHOSPHINO) PROPYLTRIETHOXYSILANE (CAS#: 52090-23-0), or VINYL (DIPHENYLPHOSPHINOETHYL)DIMETHYLSILANE (CAS#: 76734-22-0)), with an electrophilic alkyl halide (e.g., 1-CHLOROOCTADECANE (CAS#: 3386-33-2), 1-CHLOROHEXADECANE (CAS#: 4860-03-1), or CHLOROMETHANE (CAS#: 74-87-3)) to form a quaternary phosphonium organosilane with a cationic phosphonium group stabilized with the anionic halogen leaving group from the alkyl halide. In some embodiments, the active compound(s) may be dissolved or dispersed in an organic solvent or a mixture of organic solvents. Typically, the concentration of the active compound(s) in the coating composition is between about 0.1 and 10 vol.%.

In a particular aspect of the present disclosure, the tertiary sulfonium compound(s) or derivative(s) of such can include a tertiary sulfonium cation, which includes a positively charged polyatomic ion with the structure (SR₃)⁺ (R being an aryl, alkyl, phenyl, benzyl, allyl, alkenyl, or alkynyl group, and that the sulfonium cations are permanently charged regardless of the pH environment they exist in). Silyl ether, alkoxysilyl, hydroxysilyl, and silyl halide tertiary sulfonium compounds can have a general formula of:

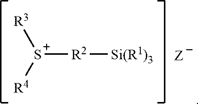

In various embodiments, R¹ is an alkoxy group, hydroxyl group, halogen, hydrogen, an alkyl group, or any combination thereof that includes at least one alkoxy/hydroxyl group. R², R³, R⁴, R⁵ are each independently hydrocarbon moieties having between 1 to 30 carbon atoms, a phenyl group, a benzyl group, a substituted alkyl group, an unsubstituted alkyl group, a substituted alkenyl group, an unsubstituted alkenyl group, a substituted alkynyl group, an unsubstituted alkynyl group, a substituted aryl group, or an unsubstituted aryl group, a substituted allyl group, an unsubstituted allyl group, or derivatives thereof. Z is an anionic atom or compound, or a halogen.

In a particular aspect of the present disclosure, silyl ether, trialkoxysilyl, and trihydroxysilyl tertiary ammonium/phosphonium compounds can have a general formula of:

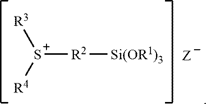

In various embodiments, R¹ is hydrogen, methyl, ethyl, propyl, isopropyl, butyl, or isobutyl groups, or a combination thereof. R², R³, R⁴, R⁵ are each independently hydrocarbon moieties having between 1 to 30 carbon atoms, a phenyl group, a benzyl group, a substituted alkyl group, an unsubstituted alkyl group, a substituted alkenyl group, an unsubstituted alkenyl group, a substituted alkynyl group, an unsubstituted alkynyl group, a substituted aryl group, or an unsubstituted aryl group, a substituted allyl group, an unsubstituted allyl group, or derivatives thereof. Z is an anionic atom or compound, or a halogen.

An example of a tertiary sulfonium organosilane described and used in the present disclosure may include, but is not limited to, S-(TRIMETHOXYSILYLPROPYL)ISOTHIOURONIUM CHLORIDE (CAS#: 84682-36-0). As a non-limiting example, the tertiary sulfonium organosilanes described and utilized in the present disclosure may be formed via reaction of a nucleophilic thioether/sulfide-functional compound (e.g., POLY(1,4-PHENYLENE SULFIDE) (CAS#: 25212-74-2)) with an electrophilic halogen-functional organosilane (e.g., 3-CHLOROPROPYLTRIMETHOXYSILANE (CAS#: 2530-87-2) or ((CHLOROMETHYL)PHENYLETHYL)TRIMETHOXYSILANE (CAS#: 68128-25-6)) via S_{N}2-type nucleophilic substitution to form a tertiary sulfonium organosilane with a cationic sulfonium group stabilized with the anionic halogen leaving group from the halogen-functional organosilane.

As another non-limiting example, the tertiary sulfonium organosilanes described and utilized in the present disclosure may be formed via reaction of a nucleophilic sulfide-functional organosilane (e.g., BIS[m-(2-TRIETHOXYSILYLETHYL)TOLYL]POLYSULFIDE (CAS#: 198087-81-9/85912-75-0/67873-85-2), BIS[TRIETHOXYSILYL)PROPYL]TETRASULFIDE (CAS#: 40372-72-3), or 3-MERCAPTOPROPYLTRIMETHOXYSILANE (CAS#: 4420-74-0)) with an electrophilic alkyl halide (e.g., 1-CHLOROOCTADECANE (CAS#: 3386-33-2), 1-CHLOROHEXADECANE (CAS#: 4860-03-1), or CHLOROMETHANE (CAS#: 74-87-3)) to form a tertiary sulfonium organosilane with a cationic sulfonium group stabilized with the anionic halogen leaving group from the alkyl halide. In some embodiments, the active compound(s) may be dissolved or dispersed in an organic solvent or a mixture of organic solvents. In some embodiments, the concentration of the active compound(s) in the coating composition is between about 0.1 and 10 vol.%.

In general, quaternary ammonium/phosphonium and tertiary sulfonium organosilanes are alkoxy-, hydroxyl-, or halide-functional organosilanes with a quaternary amine/phosphine-functional or sulfonium-functional linear/branched alkyl chain. These compounds exhibit antimicrobial/bactericidal/virucidal properties that can be effectively implemented in biocidal systems, which include, but are not limited to, microbicides, virucides, bactericides, fungicides, and algaecides. In effect, the hydrolysable alkoxy, hydroxyl, or halide moieties of a quaternary ammonium/phosphonium or tertiary sulfonium organosilane may undergo condensation reactions with silanol, hydroxyl, or halogen moieties of a polymeric host matrix and/or with other quaternary ammonium/phosphonium and/or tertiary sulfonium organosilane compounds in either the presence or absence of a catalyst. The antimicrobial properties of quaternary ammonium/phosphonium and tertiary sulfonium organosilanes arise from positively charged ammonium/phosphonium/sulfonium moieties that exhibit an affinity for the anionic heads of phospholipids that function as bilayer-forming components of most cellular membranes or outer an protein envelope/capsid of infectious agents, such as viruses. The proximity between such ammonium/phosphonium moieties and the lipid bilayers of cellular membranes is enhanced by quaternary ammonium/phosphonium and tertiary sulfonium silanes with longer alkyl chain moieties that facilitate and amplify weak intermolecular attraction between the two. This ionic interaction effectively disrupts protein-spike/outer protein envelope/capsid functionality in infectious agents and cellular activity in prokaryotes via gradual dissociation of cellular membrane lipid bilayers (lysis), which eventually results in rupturing of affected cellular membranes, leakage of cellular contents, and ultimately cellular death.

In some embodiments, the coating composition for treating the surface of materials may include hydrophobic chemical agent(s). In some embodiments, an example of hydrophobic chemical agents used includes at least one type of alkoxyfluoroalkylsilane. The hydrophobic chemical agents used may have a general formula of alkoxyfluoroalkylsilane [CF₃(CF₂)ₐ(CH₂)_{b}]_{c}SiR⁶_{d}[alkoxy]ₑ. In various embodiments, [alkoxy] includes methoxy,ethoxy, propoxy, isopropoxy, butoxy, isobutoxy, or a combination thereof. R6 includes asubstituted or unsubstituted alkyl, a substituted or unsubstituted alkenyl, a substituted orunsubstituted alkynyl, a substituted or unsubstituted aryl or derivatives thereof. Furthermore,in various embodiments, a is the integer 0, 1, 2, 3 ... to 20, b is the integer 0, 1, 2, 3... to 10, cis the integer 1, 2, 3, d is the integer 0, 1, 2, 3 and e is the integer 1, 2, 3, provided that the sumof c, d, and e equals 4. The alkoxyfluoroalkylsilane species may include, but are not limited to, trimethoxy(3,3,3-trifluoropropyl)silane, triethoxy(3,3,3-trifluoropropyl)silane, tripropoxy(3,3,3-trifluoropropyl)silane, triisopropoxy(3,3,3-trifluoropropyl)silane,trimethoxy(1H,1H2H,2H-perfluorobutyl)silane, triethoxy(1H,1H,2H,2H-perfluorobutyl)silane, tripropoxy(1H,1H,2H,2H-perfluorobutyl)silane, triisopropoxy(1H,1H,2H,2H-perfluorobutyl)silane, trimethoxy(1H,1H,2H,2H-perfluorohexyl)silane, triethoxy(1H,1H,2H,2H-perfluorohexyl)silane, tripropoxy(1H,1H,2H,2H-perfluorohexyl)silane, triisopropoxy(1H,1H,2H,2H-perfluorohexyl)silane, trimethoxy(1H,1H,2H,2H-perfluorooctyl)silane, triethoxy(1H,1H,2H,2H-perfluorooctyl)silane, tripropoxy(1H,1H,2H,2H-perfluorooctyl)silane, triisopropoxy(1H,1H,2H,2H-perfluorooctyl)silane, trimethoxy(1H,1H,2H,2H-perfluorodecyl)silane, triethoxy(1H,1H,2H,2H-perfluorodecyl)silane, tripropoxy(1H,1H,2H,2H-perfluorodecyl)silane, triisopropoxy(1H,1H,2H,2H-perfluorodecyl)silane, trimethoxy(1H,1H,2H,2H-perfluorododecyl)silane, triethoxy(1H,1H,2H,2H-perfluorododecyl)silane, tripropoxy(1H,1H,2H,2H-perfluorododecyl)silane, triisopropoxy(1H,1H,2H,2H-perfluorododecyl)silane and derivatives bearing similar structures. In some embodiments, the hydrophobic chemical agent(s) may be dissolved or dispersed in an organic solvent or a mixture of organic solvents. In some embodiments, the concentration of the hydrophobic chemical agent(s) in the coating composition is between about 0.1 and 15 vol.%.

Additionally, other chemical agents may also be used alone or in conjunction with alkoxyfluoroalkylsilanes to perform similar tasks as hydrophobic chemical agent(s). In some embodiments, other chemical agents may be hydrophobic and may have a general formula of alkoxyalkylsilane [CH₃(CH₂)ₐ]_{b}SiR⁷_{c}[alkoxy]_{d}. In various embodiments, [alkoxy] includes methoxy, ethoxy, propoxy, isopropoxy, butoxy, isobutoxy, or a combination thereof. R⁷ includes a substituted or unsubstituted alkyl, a substituted or unsubstituted alkenyl, a substituted or unsubstituted alkynyl, a substituted or unsubstituted aryl or derivatives thereof. Furthermore, in various embodiments, a is the integer 0, 1, 2, 3... to 20, b is the integer 1, 2, 3, c is the integer 0, 1, 2, 3 and d is the integer 1, 2, 3, provided that the sum of b, c and d, equals 4. The alkoxyalkylsilane species may include, but are not limited to, trimethoxyisobutylsilane, triethoxyisobutylsilane, dimethoxydiisobutylsilane, diethoxydiisobutylsilane, trimethoxy(hexyl)silane, triethoxy(hexyl)silane, tripropoxy(hexyl)silane, triisopropoxy(hexyl)silane, trimethoxy(octyl)silane, triethoxy(octyl)silane, tripropoxy(octyl)silane, triisopropoxy(octyl)silane, trimethoxy(decyl)silane, triethoxy(decyl)silane, tripropoxy(decyl)silane, triisopropoxy(decyl)silane, trimethoxy(dodecyl)silane, triethoxy(dodecyl)silane, tripropoxy(dodecyl)silane, triisopropoxy(dodecyl)silane and derivatives bearing similar structures. In some embodiments, the hydrophobic chemical agent(s) may be dissolved or dispersed in an organic solvent or a mixture of organic solvents. In some embodiments, the concentration of the hydrophobic chemical agent(s) in the coating composition is between about 0.1 and 15 vol.%.

In some embodiments, the coating composition for treating the surface of materials may include hydrophobic chemical agent(s). In some embodiments hydrophobic chemical agent(s) may include at least one functional silicone/siloxane in oligomer/co-oligomer form, polymer/co-polymer form, or a combination thereof having a non-limiting generalized formula of:

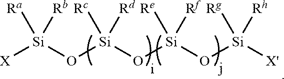

In some embodiments, the aforementioned has an average molecular weight between 100 to 100,000 Da and an average viscosity between 10 to 20,000 mPa·s. In some embodiments, R^{a}, R^{b}, R^{c}, R^{d}, R^{e}, R^{f}, R^{g}, and R^{h} are each independently hydrocarbon moieties having between 1 to 30 carbon atoms, a methyl group, a phenyl group, a benzyl group, a substituted alkyl group (e.g., aminoalkyl group, mercaptoalkyl group, or glycidoxyalkyl group), an unsubstituted alkyl group, a substituted alkenyl group, an unsubstituted alkenyl group, a substituted alkynyl group, an unsubstituted alkynyl group, a substituted aryl group, or an unsubstituted aryl group, a substituted allyl group, an unsubstituted allyl group, or derivatives/combinations thereof. R^{a}, R^{b}, R^{c}, R^{d}, R^{e}, R^{f}, R^{g}, and R^{h} may be the same or dissimilar. In some embodiments, X and X′ are an alkoxy group, hydroxyl group, halogen, hydrogen, vinyl group, mercapto/thiol group, amine group, epoxide group, unsubstituted/substituted alkene group, unsubstituted/substituted alkyne group, unsubstituted/substituted allyl group, unsubstituted/substituted alkynyl group, unsubstituted/substituted alkenyl group, an unsubstituted/substituted alkyl group, or a combination thereof. X and X′ may be the same or dissimilar. In various embodiments, i and j are integer values between 1-200,000, where i and j may or may not be equal to one another. Such functional silicone/siloxane species may include, but are not limited to, VINYL-TERMINATED DIPHENYLSILOXANE COPOLYMER (CAS#: 68951-96-2), VINYL-TERMINATED POLYDIMETHYLSILOXANES (CAS#: 68083-19-2), VINYLMETHYLSILOXANE-DIMETHYLSILOXANE COPOLYMER, TRIMETHYLSILOXY-TERMINATED (CAS#: 67762-94-1), HYDRIDE-TERMINATED POLYDIMETHYLSILOXANE (CAS#: 70900-21-9), METHYLHYDROSILOXANE-DIMETHYLSILOXANE COPOLYMER, TRIMETHYLSILOXY-TERMINATED (CAS#: 68037-59-2), METHYLHYDROSILOXANE-PHENYLMETHYLSILOXANE COPOLYMER, HYDRIDE-TERMINATED (CAS#: 115487-49-5), SILANOL-TERMINATED POLYDIMETHYLSILOXANE (CAS#: 70131-67-8), SILANOL-TERMINATED DIPHENYLSILOXANE (CAS#: 63148-59-4), SILANOL-TERMINATED POLYTRIFLUOROPROPYLMETHYLSILOXANE (CAS#: 68607-77-2), AMINOPROPYL-TERMINATED POLYDIMETHYLSILOXANE (CAS#: 106214-84-0), N-ETHYLAMINOISOBUTYL-TERMINATED POLYDIMETHYLSILOXANE (CAS#: 254891-17-3), AMINOPROPYLMETHYLSILOXANE-DIMETHYLSILOXANE COPOLYMER (CAS#: 99363-37-8), AMINOETHYLAMINOPROPYLMETHYLSILOXANE-DIMETHLSILOXANE COPOLYMER (CAS#: 71750-79-3), AMINOETHYLAMINOPROPYLMETHOXYSILANE-DIMETHYLSILOXANE COPOLYMER (CAS#: 67923-07-3), EPOXYPROPOXYPROPYL-TERMINATED POLYDIMETHYLSILOXANE (CAS#: 102782-97-8), EPOXYPROPOXYPROPYLMETHYLSILOXANE-DIMETHYLSILOXANE COPOLYMER (CAS#: 68440-71-7), EPOXYCYCLOHEXYLETHYLMETHYLSILOXANE-DIMETHYLSILOXANE COPOLYMER (CAS#: 67762-95-2), CARBINOL-TERMINATED POLYDIMETHYLSILOXANE (CAS#: 104780-66-7/68937-54-2/161755-53-9), EPOXYCYCLOHEXYLETHYLMETHYLSILOXANE-METHOXY-POLYALKYLENEOXYMETHYLSILOXANE-DIMETHYLSILOXANE TERPOLYMER (CAS#: 69669-36-9), MONOCARBINOL-TERMINATED POLYDIMETHYLSILOXANE (CAS#: 207308-30-3), MONODICARBINOL-TERMINATED POLYDIMETHYLSILOXANE (CAS#: 218131-11-4), (3-ACRYLOXY-2-HYDROXYPROPOXYPROPYL)-TERMINATED POLYDIMETHYLSILOXANE (CAS#: 128754-61-0), METHACRYLOXYPROPYL-TERMINATED BRANCHED POLYDIMETHYLSILOXANE (CAS#: 80722-63-0), SUCCINIC ANHYDRIDE-TERMINATED POLYDIMETHYLSILOXANE (CAS#: 161208-23-8), (BICYCLOHEPTENYL)ETHYL-TERMINATED POLYDIMETHYLSILOXANE (CAS#: 945244-93-9), CARBOXYALKYL-TERMINATED POLYDIMETHYLSILOXANE (CAS#: 58130-04-4), (CHLOROPROPYL)METHYLSILOXANE-DIMETHYLSILOXANE COPOLYMER (CAS#: 70900-20-8), CHLOROMETHYL-TERMINATED POLYDIMETHYLSILOXANE (CAS#: 158465-60-2), (MERCAPTOPROPYL)METHYLSILOXANE-DIMETHYLSILOXANE COPOLYMER (CAS#: 102783-03-9), CHLORINE-TERMINATED NONAFLUOROHEXYLMETHYLSILOXANE-DIMETHYLSILOXANE COPOLYMER (CAS#: 908858-79-7), MONOCARBINOL-TERMINATED POLYDIMETHYLSILOXANE-ASSYMETRIC (CAS#: 207308-30-3), MONO(2,3-EPOXY)PROPYLETHER-TERMINATED POLYDIMETHYLSILOXANE (CAS#: 1108731-31-2/127947-26-6), and derivatives of similar/analogous structure. In some embodiments, the hydrophobic chemical agent(s) may be dissolved or dispersed in an organic solvent or a mixture of organic solvents for subsequent reaction(s). In some embodiments, the concentration of the hydrophobic chemical agent(s) in the coating composition is between about 0.1 and 15 vol.%.

In some embodiments, hydrophobic chemical agent(s) may include at least one functional silicone/siloxane in oligomer/co-oligomer form, polymer/co-polymer form, or a combination thereof, in combination with a substituted/unsubstituted alkyl functional silyl ether, halogensilane, or silyl hydride having a non-limiting generalized formula of:

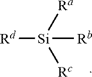

In various embodiments, R^{a}, R^{b}, R^{c}, and R^{d} are each independent hydrocarbon moieties having between 1 to 30 carbon atoms, a methyl group, a phenyl group, a benzyl group, a substituted alkyl group (e.g., aminoalkyl group, mercaptoalkyl group, glycidoxyalkyl group), an unsubstituted alkyl group, a substituted alkenyl group, an unsubstituted alkenyl group, an alkoxy group, a hydroxyl group, a hydrogen atom, or a halogen. R^{a}, R^{b}, and R^{c} may be the same or dissimilar so long as there exists at least one alkoxy group, hydroxyl group, hydrogen atom, or halogen among R^{a}, R^{b}, and R^{c}. Such substituted/unsubstituted alkyl-functional silyl ethers, halogensilanes, and silylhydrides can include, but are not limited to, trimethoxy(hexyl)silane, triethoxy(hexyl)silane, tripropoxy(hexyl)silane, tri-isopropoxy(hexyl)silane, trimethoxy(octyl)silane, triethoxy(octyl)silane, tripropoxy(octyl)silane, tri-isopropoxy(octyl)silane, trimethoxy(decyl) silane, triethoxy(decyl)silane, tripropoxy(decyl)silane, tri-isopropoxy(decyl)silane, trimethoxy(dodecyl)silane, triethoxy(dodecyl)silane, tripropoxy(dodecyl)silane, tri-iso propoxy(dodecyl)silane, and derivatives bearing similar structures.

In some embodiments, the coating composition for treating the surface of materials may include solvent(s). In some embodiments, the solvent(s) used to disperse all the components to form a homogeneous solution may include, but is not limited to, water, methanol, ethanol, n-propanol, isopropanol, n-butanol, isobutanol, ethylene glycol, glycerol acetone, acetonitrile, dioxane, tetrahydrofuran, dimethylformamide, dimethyl sulfoxide, dimethyl carbonate, propylene carbonate, methyl acetate, ethyl acetate, 4-chlorobenzotrifluoride, odorless mineral spirits, or a mixture/combination thereof. In some embodiments, the use of carrier solvents such as alcohols (e.g. solutions with >70% ethanol) serve duel purposes, as they act as carrier agents for the solution and active compound(s), as well as acting as a disinfecting agent when applied to a surface by sterilizing the surface of unwanted bacteria and viruses before the solution be fully cured through a crosslinking process. The solvent(s) can be combined with the ingredients through a “wet process” misting mechanism or even vapor treatment method to disperse all the components to form a homogeneous entity.

In some embodiments, the coating composition may include a base compound to a core unit or base of a sol-gel network. In some embodiments, the coating composition may include bonding agents to aid bonding of the coating to the desired surface. In some embodiments, the coating composition may include a plasticizer to maintain elasticity of the sol-gel. In some embodiments, the coating composition can include a chelating agent to enhance homogeneity of the organic/inorganic compounds or portions of compounds in the solution. The base compound used in the present disclosure has a base compound has a general formula of M(OR⁶)₄, where M is Si, Al, Ti, In, Sn or Zr, and R⁶ is a hydrogen, a substituted or unsubstituted alkyl group or a derivative thereof. In an embodiment, the base compound is tetraethyl orthosilicate (Si(OCH₂CH₃)₄). The bonding compound used in the present disclosure has a general formula of M(OR⁷)ₓ, R⁸_{y} R⁹_{z}, where M is Si, Al, In, Sn or Ti, R⁷ is a hydrogen, a substituted or unsubstituted alkyl group or derivatives thereof, R⁸ is a hydrogen, a substituted or unsubstituted alkyl group or derivatives thereof, R⁹ is a substituted or unsubstituted epoxy or glycidoxy group, and x and z are each independent integers from 1 to 3, y is an integer from 0 to 2, and the sum of x, y, and z is 4. In some embodiments, the bonding agent is 3-glycidoxypropyltrimethoxysilane (Si(OCH₃)₃glycidoxy). The plasticizer used in the coating composition has the general formula of M(OR¹⁰)₄₋ₓ R¹¹ₓ, where M is Si, Al, In, Sn or Ti, R¹⁰ is a hydrogen, a substituted or unsubstituted alkyl group or derivatives thereof, and R¹¹ is a substituted or unsubstituted alkyl group, a substituted or unsubstituted alkenyl group, a substituted or unsubstituted alkynyl group, a substituted or unsubstituted aryl group or a derivative thereof, and x is 1, 2 or 3. In an embodiment, the plasticizer is trimethoxypropylsilane (Si(OCH₃)₃CH₂CH₂CH₃). In some embodiments, the chelating agent is an alkoxysilane, metal oxide precursor, or both having the general formula of M(OR¹²)ₓR¹³_{y} R¹⁴_{z}, where M is Si, Al, In, Sn or Ti, R¹² includes a hydrogen, a substituted or unsubstituted alkyl group or derivatives thereof, R¹³ includes a hydrogen, a substituted or unsubstituted alkyl group or derivatives thereof, R¹⁴ includes a substituted or unsubstituted alky or alkenyl group having from 3 to 20 carbon atoms or a substituted or unsubstituted amine (including primary, secondary and tertiary) or thiol, and x and z are each independently an integer from 1 to 3, y is an integer from 0 to 2, and the sum of x, y, and z is 4.

In some embodiments, the coating composition can be prepared by: (a) obtaining at least one active compound, at least one hydrophobic chemical agent, and optionally a base compound, bonding agent, plasticizer or chelating agent; (b) adding the above mentioned ingredients to a solvent(s) to form a solution/mixture; and (c) optionally mixing the solution/mixture with water under acidic conditions (e.g., a pH of 6 or less, or a pH less than 5) to form a homogeneous sol-gel solution. The solution can be stirred at a temperature from about 50 to 100° C. for between about 10 seconds (fast-reactions) to 10 days (slower reactions). The quaternary ammonium compound(s) or derivative(s) of such are either chemically reacted to the hydrophobic chemical agent(s) to form covalent bonds or physically entrapped/encapsulated with the materials used for the coating.

In an additional aspect, the present disclosure relates to a method of coating a substrate in need of a coating, and can generally include: (a) obtaining a substrate (e.g., fabrics, porous substrates and tarps, textiles, fiber materials used for manufacturing air filters, masonry materials, or aquatic structures); and (b) applying to the substrate the coating composition(s) of the present disclosure. In some embodiments, the coating composition imparts virucidal/bactericidal/biocidal and water repellent properties to the substrate. Virucidal/bactericidal properties can be imparted to the outside surfaces of the substrate, impregnated in the substrate, or chemically incorporated into the substrate. In some embodiments, the coating composition can be deposited on the surface of substrates by spraying, misting, doctor-blading, padding, foaming, flooding, dipping, rolling or inkjet printing. In some embodiments, the coating composition is applied by: (a) contacting the substrate with a solution having the coating composition and a solvent to coat the substrate; and (b) subjecting the coated material to conditions sufficient to remove the solvent and dry the material, where at least a portion of the coating composition penetrates the surface of the substrate. The conditions of step (b) can include a temperature of about 25 to 200° C. and/or can be sufficient to crosslink the sol-gel.

In some embodiments, the present disclosure pertains to a method of inhibiting leaching of active compound(s) (e.g., quaternary ammonium/phosphonium compound(s), tertiary sulfonium compound(s), or derivative(s) of such) from a substrate. The method can generally include: (a) applying coating compositions as described herein; and (b) drying the coated substrate. The coating composition inhibits leaching of active compound(s) from the substrate by forming covalent bonds with the coating composition or physically entrapped/encapsulated within the coating composition.

In a further embodiment, the present disclosure relates to compositions and methods for making coating compositions for substrates. In a particular aspect, a hydrophobic coating composition capable of resisting COVID is described below. The hydrophobic coating composition can include at least one active compound (e.g., a quaternary ammonium compound or derivative of such) and a sol-gel solution derived from at least one base compound, at least one bonding agent, and at least one plasticizer. The coating composition is capable of providing the active component to an inner surface of the substrate (e.g., the active component is distributed throughout the substrate). In a particular aspect, the quaternary ammonium compound or derivative of such can include a quaternary ammonium cation which includes a positively charged polyatomic ion with the structure NR+ (R being an aryl or alkyl group and that the ammonium cations are permanently charged regardless of the pH environment they exist in. Alkoxysilyl quaternary ammonium compounds can have a general formula of:

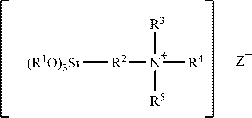

In some embodiments, R¹ is methyl, ethyl, propyl, isopropyl, butyl, isobutyl, or a combination thereof, R², R³, R⁴, R⁵ are each independently hydrocarbon moieties having between 1 to 30 carbon atoms, a substituted alkyl group, a unsubstituted alkyl group, a substituted alkenyl group, an unsubstituted alkenyl group, a substituted alkynyl group, an unsubstituted alkynyl group, a substituted aryl group, or an unsubstituted aryl group or derivatives thereof, and Z is an anionic atom or compound, or a halogen.

In some embodiments, the coating composition for treating the surface of materials may include a solvent. The solvent can be combined with the ingredients through a “wet process” misting mechanism or even vapor treatment method to disperse all the components to form a homogeneous entity. In some embodiments, the coating composition may include a base compound to a core unit or a base of the sol-gel network. In some embodiments, the coating composition may include bonding agent to aid bonding of the coating to a desired surface. In some embodiments, the coating composition may include a plasticizer to maintain elasticity of the sol-gel. In some embodiments, the coating composition may include a viscosity modifier to achieve a desired viscosity for the sol-gel. In some embodiments, the coating composition can include a chelating agent to enhance homogeneity of the organic/inorganic compounds or portions of compounds in the solution. The base compound used herein can have a general formula of M(OR⁶)₄, where M is Si, Al, Ti, In, Sn or Zr, and R⁶ is a hydrogen, a substituted or unsubstituted alkyl group, or a derivative thereof. In an embodiment, the base compound is tetraethyl orthosilicate (Si(OCH₂CH₃)₄). The bonding compound can have a general formula of M(OR⁷)ₓ R⁸_{y} R⁹_{z},. In some embodiments, M is Si, Al, In, Sn or Ti, R⁷ is a hydrogen, a substituted or unsubstituted alkyl group or derivatives thereof, R⁸ is a hydrogen, a substituted or unsubstituted alkyl group or derivatives thereof, R⁹ is a substituted or unsubstituted epoxy or glycidoxy group, and x and z are each independent integers from 1 to 3, y is an integer from 0 to 2, and the sum of x, y, and z is 4. In an embodiment, the bonding agent is 3-glycidoxypropyltrimethoxysilane (Si(OCH₃)₃glycidoxy). The plasticizer used in the coating composition can have the general formula of M(OR¹⁰)₄₋ₓ R¹¹ₓ, where M is Si, Al, In, Sn or Ti, R¹⁰ is a hydrogen, a substituted or unsubstituted alkyl group or derivatives thereof, and R¹¹ is a substituted or unsubstituted alkyl group, a substituted or unsubstituted alkenyl group, a substituted or unsubstituted alkynyl group, a substituted or unsubstituted aryl group or a derivative thereof, and x is 1, 2 or 3. In some embodiments, the plasticizer is trimethoxypropylsilane (Si(OCH₃)₃CH₂CH₂CH₃). In some embodiments, the chelating agent is an alkoxysilane, metal oxide precursor, or both having the general formula of M(OR¹²)ₓR¹³_{y} R¹⁴_{z}, where M is Si, Al, In, Sn or Ti, R¹² includes a hydrogen, a substituted or unsubstituted alkyl group or derivatives thereof, R¹³ includes a hydrogen, a substituted or unsubstituted alkyl group or derivatives thereof, R¹⁴ includes a substituted or unsubstituted alky or alkenyl group having from 3 to 20 carbon atoms or a substituted or unsubstituted amine (including primary, secondary and tertiary) or thiol, and x and z are each independently an integer from 1 to 3, y is an integer from 0 to 2, and the sum of x, y, and z is 4. In some embodiments, the viscosity modifier is an alkoxysilane oligomer having the general structure of:

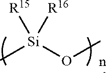

In various embodiments, R¹⁵ and R¹⁵ can be the same or different and can include, without limitation, hydrogen, a substituted or unsubstituted alkyl, or derivatives thereof. Quaternary ammonium organosilanes belong to a broader class of compounds referred to as quaternary ammonium compounds/cations.

In general, quaternary ammonium organosilanes are trialkoxy-/trihalide-functional silanes with a quaternary amine-functional linear/branched alkyl chain. These compounds exhibit antimicrobial properties that can be effectively implemented in biocidal systems, which include, but are not limited to, microbicides, fungicides, bactericides, and algaecides. In effect, the hydrolysable alkoxy or halide moieties of a quaternary ammonium organosilane may undergo condensation reactions with silanol, hydroxyl, or halogen moieties of a polymeric host matrix and/or with other quaternary ammonium organosilane compounds in either the presence or absence of a catalyst. The antimicrobial properties (e.g., antiviral properties) of quaternary ammonium organosilanes arise from positively charged ammonium moieties that exhibit an affinity for the anionic heads of phospholipids that function as critical bilayer-forming components of most cellular membranes. The proximity between such ammonium moieties and the lipid bilayers of cellular membranes is enhanced by quaternary ammonium silanes with longer alkyl chain moieties that facilitate weak intermolecular attraction between the two. This ionic interaction effectively disrupts cellular activity via gradual dissociation of cellular membrane lipid bilayers (lysis), which eventually results in rupturing of affected cellular membranes, leakage of cellular contents, and ultimately cellular death.

Examples of quaternary ammonium organosilanes are DIMETHYLOCTADECYL[(3-TRIMETHOXYSILYL)PROPYL] AMMONIUM CHLORIDE (CAS#: 27668-52-6), 3-(TRIMETHOXYSILYL)PROPYL-N,N,N-TRIMETHYLAMMONIUM CHLORIDE (CAS#: 35141-36-7), TETRADECYLDIMETHYL(3-TRIMETHOXYSILYLPROPYL)AMMONIUM CHLORIDE, N,N-DIDECYL-N-METHYL-N-(3-TRIMETHOXYSILYLPROPYL)AMMONIUM CHLORIDE (CAS#: 68959-20-6), OCTADECYLBIS(TRIETHOXYSILYLPROPYL)AMMONIUM CHLORIDE, 3-(N-STYRYLMETHYL-2-AMINOETHYLAMINO)PROPYLTRIMETHOXYSILANE HYDROCHLORIDE (CAS#: 34937-00-3), S-(TRIMETHOXYSILYLPROPYL) ISOTHIOURONIUM CHLORIDE (CAS#: 84682-36-0), N-(2-N-BENZYLAMINOETHYL)-3-AMINOPROPYLTRIMETHOXYSILANE HYDROCHLORIDE (CAS#: 623938-90-9), TETRADECYLDIMETHYL(3-TRIMETHOXYSILYLPROPYL)AMMONIUM CHLORIDE (CAS#: 41591-87-1), and 4-(TRIMETHOXYSILYLETHYL)BENZYLTRIMETHYL AMMONIUM CHLORIDE.

In some embodiments, the coating composition can be prepared by: (a) obtaining atleast one active ingredient, at least one base compound, at least one bonding agent, and at least one plasticizer; (b) adding at least one active ingredient, at least one base compound, at least one bonding agent, and at least one plasticizer to a solvent to form a solution/mixture; and (c) mixing the solution/mixture with water under acidic conditions (e.g., a pH of 6 or less, or a pH less than 5) to form a homogeneous sol-gel solution. The solution can be stirred at a temperature from 50 to 100° C. for about ½ hour to 10 days. The quaternary ammonium compound or derivative of such are either chemically reacted or physically entrapped/encapsulated with the materials used for the coating. In an aspect, the present disclosure relates to a method of coating a substrate in need of a coating, and can generally include: (a) obtaining a substrate (e.g., fabrics, porous substrates and tarps, textiles, fiber materials used for manufacturing air filters, masonry materials, or aquatic structures); and (b) applying to the substrate the coating compositions as disclosed herein, where the coating composition imparts antiviral and water resistance properties to the substrate. The SARSR-CoV, or other similar SARSR-CoV resistance, can be imparted to the outside surface of the substrate, impregnated in the substrate, or incorporated into the substrate. In some embodiments, the coating composition can be deposited on the surface of substrates by spraying, misting, doctor-blading, padding, foaming, rolling or inkjet printing. In some embodiments, the coating composition is applied by: (a) contacting the substrate with a solution including the coating composition and a solvent to coat the substrate; and (b) subjecting the coated material to conditions sufficient to remove the solvent and dry the material, where at least a portion of the coating composition penetrates the surface of the substrate. The conditions of step (b) can include a temperature of 25 to 200° C. and/or can be sufficient to crosslink the sol or sol-gel. In some embodiments, a surface treated with of a hydrophobic compound (e.g., fluoroalkylsilane compound, an alkylsilane compound, and an alkoxyfluoroalkylsilane compound) can be used to increase the surface hydrophobicity of the resulting composite. The coating composition, hydrophobic composition, or both can generate a nanoscopic or a microscopic topography on the surface of the material.

In some embodiments, a method of inhibiting leaching of an active compound (e.g., a quaternary ammonium compound or derivative of such) from a substrate is further disclosed. The method can generally include: (a) applying a coating composition as described herein; and (b) drying the coated substrate. In some embodiments, the coating composition inhibits leaching of the active compound from the substrate.

As used herein, the term “hydrophobic” refers to a property of a material where the material impedes the wetting and/or absorption of water or water based liquids. In general, a material lacking affinity to water may be described as displaying “hydrophobicity”.

As used herein, the term “oleophobic” refers to a property of a material where the material impedes wetting and/or absorption of oil or oil-based liquids.

As used herein, the term “virucidal”, “antiviral”, “viral resistant”, or “viral reduction” refers to the ability of a material to deactivate, inhibit, and/or lyse viruses, inhibit/thwart transmission of infectious agents/contagions, or minimize host-cell damage, transformation, growth, nucleation, twinning, reproduction of the infectious agent/pathogen/contagion. Additionally, the term “viral resistant” referes to the ability of a material to resist entrance of viruses or inhibit. In a particular aspect, this also encompasses the ability of a material to resist the attack or layering (settling on the surface) of infectious agents/contagions like enveloped viruses, including, but not limited to, for example, SARS-CoV, influenza A viruses, and Ebola viruses.

As used herein, the term “bactericidal”, “antibacterial”, “bacterial resistant”, or “bacterial reduction” refers to the ability of a material to destroy bacteria, or resist entrance of bacteria, or suppresses their growth or their ability to reproduce. More specifically, it is also refers to the ability of a material to resist the attack of bacteria including, but not limited to, Staphylococcus aureus, Methicillin-resistant Staphylococcus aureus, Vancomycin-resistant Enterococci, Enterococcus faecalis, Salmonella enterica, and Pseudomonas aeruginosa.

As used herein, the term “antimicrobial” in the context of this disclosure is a term used to describe any applicable surface or material that has been coated, sealed or treated to impart the ability to kill microorganisms (i.e., “microbicidal”) and substantially inhibit their growth. The United States Environmental Protection Agency (EPA) states this use as to disinfect, sanitize, reduce, or mitigate growth or development of microbiological organisms. Generally, the application is to protect against bacteria and viruses, including, but not limited to, SARS-CoV species. Indeed, as a more specific designation, one may also define and differentiate the microbe(s) being killed such as, for example, SARS-CoV, the term would be specifically antiviral. A surface or material that exhibits limited antimicrobial behavior or properties is said to be “microbial resistant”. Specifically, the material may be seen to inhibit or impede the rate at which microbes proliferate on or attach to a surface.

As used herein, the terms “anti-SARS-CoV”, “SARSR-CoV”, “SARS-CoV-resistance”, “SARSR-CoV-resistance” are defined as a property exhibited by specifically designed functional coatings or functionalized/chemically-modified surfaces that either inhibit or aid in the removal of a select assortment of SARS-CoV agents.

As used herein, the terms “SARS-CoV-contaminated” and “SARSR-CoV-contaminated” refer to the undesired settlement, anchoring, and/or colonization of the aforementioned SARS-CoV/SARSR-CoV agents on the surfaces or internal components of SARS-CoV/SARSR-CoV agents adhered to fabrics used in personal protective equipment in hospitals or care facilities.

As used herein, the coatings of the present disclosure can include any ingredients, components, compositions, and the like as disclosed herein. With respect to the transitional phases, for example, in a non-limiting aspect, a basic and novel characteristic of the coatings of the present disclosure include, but are not limited to, their abilities to provide SARSR-CoV resistance and water repellency for a substrate, which inhibits leaching of the quaternary ammonium compound or derivative of such from the substrate.

Reference will now be made to more specific embodiments of the present disclosure and data that provides support for such embodiments. However, it should be noted that the disclosure below is for illustrative purposes only and is not intended to limit the scope of the claimed subject matter in any way.

Below are detailed descriptions of the standardized test methods used to evaluate the efficacy of treated samples with respect to aqueous liquid repellency and stain-resistance. The treatments were done on specific denier fibers, but can vary depending on the number of filaments and size of the denier and so the American Association of Textile Chemists and Colorists (AATCC) test results may vary. When testing non-woven fibers or other three-dimensional (3D) filaments, the length and density may also alter the AATCC results.

AATCC Test Method 193-2012 (Aqueous Liquid Repellency (ALR): Water/Alcohol Solution Resistance Test). The purpose of this test method is to determine the efficacy of coatings that can reduce the effective surface energy of arbitrary fabric material in regard to the treated surface’s ability to resist wetting by a specific series of water/isopropanol solutions. This test method implements 8 aqueous isopropanol solutions, numbered 1 to 8 of varying volumetric ratios (1 = largest water: i-PrOH volumetric ratio and 8 = smallest water: i-PrOH volumetric ratio), which correspond to different surface energies. The test is conducted by placing a minimum of three 0.050 mL drops of solution, beginning with the lowest numbered test solution, and spaced ~4.0 cm apart from one another with the applicator tip held at a height of ~0.60 cm above the surface of a flat test specimen. In order to receive a passing grade, the test solution must remain on the surface of the test specimen for 10 ± 2.0 seconds without darkening, wetting, or wicking into the fibers of the test specimen. Correspondingly, the aqueous liquid repellency grade of the test specimen is the highest numbered test solution that receives a passing grade.

AATCC Test Method 118-2012 (Oil Repellency (OR): Hydrocarbon Resistance Test). The purpose of this test method is to determine the degree of surface fluorination or other surface finish that may impart a low surface energy to a treated test specimen. Eight hydrocarbon solutions numbered 1 to 8 are used to evaluate the surface energy properties of treated test specimens. The test is conducted by placing a minimum of three 0.050 mL drops of solution, beginning with the lowest numbered test solution, and spaced ~4.0 cm apart from one another with the applicator tip held at a height of ~0.60 cm above the surface of a flat test specimen. In order to receive a passing grade, the test solution must remain on the surface of the test specimen for 30 ± 2.0 seconds without darkening, wetting, or wicking into the fibers of the test specimen. Correspondingly, the oil repellency grade of the test specimen is the highest numbered test solution that receives a passing grade.

The following describes a one-stage wet-chemical treatment process for imparting fiber materials with hydrophobic, oleophobic, and virucidal/bactericidal/biocidal properties.

Example I. The solution was prepared by dispersing enough of a hydrophobic chemical reagent: triethoxy(1H,1H,2H,2H-perfluorooctyl)silane and a quaternary ammonium organosilane: Dimethyloctadecyl[3-(trimethoxysilyl)propyl]ammonium chloride into an aqueous methanol solution and allowed to mix under an acidic condition (pH < 1). After heated mixing, the solution was neutralized with KOH (may contain up to 15% (wt./wt.) of water) until the pH reached a value between 6 and 9. The solution was allowed to settle prior to filtration to remove excess insoluble salts. The solution mentioned above was then used to treat three separately fiber materials, made of non-woven polypropylene/polyester fibers, cotton textile and nylon/polyester textile. The fiber materials were treated with the solution by immersing the samples in a solution bath. After fully wetting the samples, excess solution was removed by suspending the saturated sample in the air until enough solution was drained from the sample to attain a target %-weight pick-up ranging between 350 - 400% (wt./wt.) for non-woven polypropylene/polyester fibers, 250 - 280% (wt./wt.) for cotton textile and 120 - 130% (wt./wt.) for nylon/polyester textile, respectively. The samples were then allowed to air dry/cure under blowing hot air (40 - 50° C.) prior to efficacy evaluation. The following test methods were conducted to evaluate the surface energy of the treated samples at the air-fiber materials interface: AATCC Test Method 193-2012 and AATCC Test Method 118-2012. Correspondingly, the treated samples received ALR/OR grades of 8/6 for non-woven polypropylene/polyester fibers, ALR/OR grades of 8/5 for cotton textile and ALR/OR grades of 6/3 for nylon/polyester textile.

Example II. The solution was prepared by dispersing enough of a hydrophobic chemical reagent: triethoxy(1H,1H,2H,2H-perfluorooctyl)silane and a quaternary ammonium organosilane: Dimethyloctadecyl[3-(trihydroxysilyl)propyl]ammonium chloride into an aqueous methanol solution and allowed to mix under an acidic condition (pH < 1). After heated mixing, the solution was neutralized with KOH (may contain up to 15% (wt./wt.) of water) until the pH reached a value between 6 and 9. The solution was allowed to settle prior to filtration to remove excess insoluble salts. The solution mentioned above was then used to treat three separately fiber materials, made of non-woven polypropylene/polyester fibers, cotton textile and nylon/polyester textile. The fiber materials were treated with the solution by immersing the samples in a solution bath. After fully wetting the samples, excess solution was removed by suspending the saturated sample in the air until enough solution was drained from the sample to attain a target %-weight pick-up ranging between 330 - 380% (wt./wt.) for non-woven polypropylene/polyester fibers, 250 - 280% (wt./wt.) for cotton textile and 125 - 135% (wt./wt.) for nylon/polyester textile, respectively. The samples were then allowed to air dry/cure under blowing hot air (40 - 50° C.) prior to efficacy evaluation. The following test methods were conducted to evaluate the surface energy of the treated samples at the air-fiber materials interface: AATCC Test Method 193-2012 and AATCC Test Method 118-2012. Correspondingly, the treated samples received ALR/OR grades of 8/5 for non-woven polypropylene/polyester fibers, ALR/OR grades of 8/3 for cotton textile and ALR/OR grades of 7/2 for nylon/polyester textile.

The following non-limiting examples describe non-fluorinated one-stage wet-chemical treatment processes for imparting fiber materials with hydrophobic and virucidal/bactericidal/biocidal properties:

Example III. A non-fluorinated solution was prepared by dispersing a specified amount of hydrophobic chemical reagent (methoxy-terminated aminoethylaminopropylmethylsiloxane-dimethylsiloxane copolymer) prediluted in a solvent blend of 4-chlorobenzotrifluoride and dimethyl carbonate, into a solvent blend of 4-chlorobenzotrifluoride and odorless mineral spirits (i.e. odorless Stoddard solvent) under stirring. A specified amount of (3-glycidoxypropyl)trimethoxysilane is added dropwise to the resulting mixture under stirring along with a specified amount of acetone. The resulting mixture was allowed to react at 40° C. for 5 minutes before adding specified amounts of octadecyldimethyl(3-trimethoxysilylpropyl)ammonium chloride and 3-chloropropyltrimethoxysilane. The resulting mixture was allowed to react under stirring at 40° C. for 5 minutes before adding a specified amount of n-propyltrimethoxysilane in pulsed additions over 10 minutes. The resulting solution had a reaction/final pH of ~4.7, and was allowed to react at 40° C. for an additional 4 hours to obtain the final solution. The final solution aforementioned was then used to treat three separate fibrous materials; namely, non-woven polypropylene/polyester fiber mesh, cotton textile, and nylon/polyester textile. The fibrous substrate materials were treated with the solution by immersing the samples in a solution bath. After fully wetting the samples, excess solution was removed by suspending the saturated sample in the air until enough solution was drained from the sample to attain a target %-weight pick-up ranging between 350 - 400% (wt./wt.) for non-woven polypropylene/polyester fibers, 250 - 300% (wt./wt.) for cotton textile and 250 - 300% (wt./wt.) for nylon/polyester textile, respectively. The samples were then allowed to air dry/cure for 20 minutes at room temperature conditions then cured in a forced-draft oven at 60° C. for 25 min prior to efficacy evaluation. The following test methods were conducted to evaluate the surface energy of the treated samples at the air-fiber materials interface: AATCC Test Method 193-2012 and AATCC Test Method 118-2012. Correspondingly, the treated samples received ALR/OR grades of 4/0 for non-woven polypropylene/polyester fibers, ALR/OR grades of 4/0 for cotton textile, and ALR/OR grades of 5/0 for nylon/polyester textile.

Example IV. A non-fluorinated solution was prepared by dispersing a specified amount of hydrophobic chemical reagent (methoxy-terminated aminoethylaminopropylmethylsiloxane-dimethylsiloxane copolymer) prediluted in a solvent blend of 4-chlorobenzotrifluoride and dimethyl carbonate, into a solvent blend of 4-chlorobenzotrifluoride and odorless mineral spirits (i.e., odorless Stoddard solvent) under stirring. A specified amount of (3-glycidoxypropyl)trimethoxysilane is added dropwise to the resulting mixture under stirring along with a specified amount of acetone. The resulting mixture was allowed to react at 40° C. for 5 minutes before adding specified amounts of octadecyldimethyl(3-trihydroxysilylpropyl)ammonium chloride. The resulting mixture was allowed to react under stirring at 40° C. for 5 minutes before adding a specified amount of n-octyltriethoxysilane in pulsed additions over 10 minutes. The resulting solution had a reaction/final pH of ~4.7, and was allowed to react at 40° C. for an additional 4 hours to obtain the final solution. The final solution aforementioned was then used to treat three separate fibrous materials; namely, non-woven polypropylene/polyester fiber mesh, cotton textile, and nylon/polyester textile. The fibrous substrate materials were treated with the solution by immersing the samples in a solution bath. After fully wetting the samples, excess solution was removed by suspending the saturated sample in the air until enough solution was drained from the sample to attain a target %-weight pick-up ranging between 350 - 400% (wt./wt.) for non-woven polypropylene/polyester fibers, 250 - 300% (wt./wt.) for cotton textile and 250 - 300% (wt./wt.) for nylon/polyester textile, respectively. The samples were then allowed to air dry/cure for 20 minutes at room temperature conditions then cured in a forced-draft oven at 60° C. for 25 min prior to efficacy evaluation. The following test methods were conducted to evaluate the surface energy of the treated samples at the air-fiber materials interface: AATCC Test Method 193-2012 and AATCC Test Method 118-2012. Correspondingly, the treated samples received ALR/OR grades of 4/0 for non-woven polypropylene/polyester fibers, ALR/OR grades of 5/0 for cotton textile, and ALR/OR grades of 5/0 for nylon/polyester textile.

The following non-limiting example describes a non-fluorinated/fluorinated hybrid one-stage wet-chemical treatment process for imparting fiber materials with hydrophobic/oleophobic and viricidal/bactericidal/biocidal properties:

Example V. A nonfluorinated/fluorinated hybrid solution was prepared by dispersing a specified amount of hydrophobic chemical reagent (methoxy-terminated aminoethylaminopropylmethylsiloxane-dimethylsiloxane copolymer) prediluted in a solvent blend of 4-chlorobenzotrifluoride and dimethyl carbonate, into a solvent blend of 4-chlorobenzotrifluoride and odorless mineral spirits (i.e., odorless Stoddard solvent) under stirring. A specified amount of (3-glycidoxypropyl)trimethoxysilane is added dropwise to the resulting mixture under stirring along with a specified amount of acetone. The resulting mixture was allowed to react at 40° C. for 5 minutes before adding specified amounts of octadecyldimethyl(3-trimethoxysilylpropyl)ammonium chloride and 3-chloropropyltrimethoxysilane. The resulting mixture was allowed to react under stirring at 40° C. for 5 minutes before adding a specified amount of (tridecafluoro-1,1,2,2-tetrahydooctyl)triethoxysilane in pulsed additions over 10 minutes. The resulting solution had a reaction/final pH of ~4.7, and was allowed to react at 40° C. for an additional 1 hour to facilitate partial hydrolyzation prior to adding a small amount of bismuth neodecanoate catalyst. The resulting mixture was reacted for an additional 4 hours to obtain the final solution. The final solution aforementioned was then used to treat three separate fibrous materials; namely, non-woven polypropylene/polyester fiber mesh, cotton textile, and nylon/polyester textile. The fibrous substrate materials were treated with the solution by immersing the samples in a solution bath. After fully wetting the samples, excess solution was removed by suspending the saturated sample in the air until enough solution was drained from the sample to attain a target %-weight pick-up ranging between 350 - 400% (wt./wt.) for non-woven polypropylene/polyester fibers, 250 - 300% (wt./wt.) for cotton textile and 250 - 300% (wt./wt.) for nylon/polyester textile, respectively. The samples were then allowed to air dry/cure for 20 minutes at room temperature conditions then cured in a forced-draft oven at 60° C. for 25 min prior to efficacy evaluation. The following test methods were conducted to evaluate the surface energy of the treated samples at the air-fiber materials interface: AATCC Test Method 193-2012 and AATCC Test Method 118-2012. Correspondingly, the treated samples received ALR/OR grades of 7/2 for non-woven polypropylene/polyester fibers, ALR/OR grades of 7/2 for cotton textile, and ALR/OR grades of 7/2 for nylon/polyester textile.

Example Vl. A sol-gel solution composed of a mixture of a quaternary ammonium organosilane: Dimethyloctadecyl[3-(trimethoxysilyl)propyl]ammonium chloride, a structural base reagent (tetraethyl orthosilicate), a plasticizer (trimethoxypropylsilane), a bonding agent (3-glicydyloxypropyltrimethoxysilane), a solvent (at least 70% v./v. ethanol) and water was prepared under an acidic condition (pH = 5, adjusted with HCl) by mixing the aforementioned chemicals. The resulting solution can also act as a disinfecting agent when applied to a surface by sterilizing the surface of unwanted bacteria and viruses.

In view of the aforementioned, the present disclosure generally relates to coating/carrier compositions and methods of using/applying/impregnating the composition(s) to treat porous or nonporous substrates to provide protection against including the SARSR-CoV family of virusesinfectious agent(s)/contagion(s)/pathogen(s) that cause infectious diseases, such as COVID-19, via mechanisms-of-action that include but are not limited to deactivation, inhibition, termination, and/or lysis of the infectious agent(s)/contagion(s)/pathogen(s), or via unraveling their protein membranes. The coating composition can includes at least one active compound(s), potentially derivative(s) of quaternary ammonium/phosphonium compound(s) or tertiary sulfonium compound(s) (e.g., in a sol gel system) acting as a cationic anti-infectious agent, virucide, and/or bactericide and a solution derived from least one of a base compound, a bonding agent, a hydrophobic chemical agent, a plasticizer, and a solvent. The coating composition is generally hydrophobic in nature, and is suitable for treating, coating, functionalizing, or impregnating porous/nonporous substrates, including but not limited to functionalization of porous plastics, layering on tarpaulin-substrates, coating/functionalizing synthetic/organic fibers such as those used in manufacturing fabrics, textiles, linens, garments, masks, and PPE.

Although various embodiments of the present disclosure have been described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group.

The terms “a”, “an”, and other singular terms are intended to include the plural forms thereof unless specifically excluded.

What is claimed is:

1. A method of coating a substrate to impart antiviral and water resistance to the substrate, the method comprising:
obtaining a substrate;
applying a coating composition to the substrate, wherein the coating composition imparts antiviral and water resistance properties to the substrate; and
wherein the coating composition has an antiviral method of action against a virus by causing damage to at least one of a capsid of the virus, an outer envelope of a protein layer of the virus, a spike protein of the virus, a cellular membrane of the virus, or combinations thereof.

2. The method of claim 1, wherein the applying comprises at least one of coating an outside surface of the substrate with the coating composition, impregnating the substrate with the coating composition, or incorporating the coating composition with the substrate.

3. The method of claim 1, wherein the coating composition is applied by a method selected from the group consisting of spraying, misting, vapor deposition, doctor-blading, padding, foaming, rolling, and inkjet printing.

4. The method of claims 1, wherein the applying comprises:
contacting the substrate with a solution comprising the coating composition and a solvent to coat the substrate;
subjecting the coated material to conditions to remove the solvent and dry the material; and
wherein at least a portion of the coating composition penetrates the surface of substrate.

5. The method of claim 1, wherein the coating composition is hydrophobic, and wherein
the coating composition comprises:
at least one active compound comprising at least one of a quaternary ammonium compound, a quaternary phosphonium compound, or a tertiary sulfonium compound; and
a sol-gel derived from at least one base compound, at least one bonding agent, and at least one plasticizer.

6. The method of claim 5, wherein the at least one active compound is capable of chemically reacting with a component selected from the group consisting of the at least one base compound, the at least one bonding agent, the at least one plasticizer, and combinations thereof, or is encapsulated within the sol-gel network.

7. The method of claim 5, wherein the active compound comprises a quaternary ammonium compound or derivative capable of killing a virus.

8. The method of claims 7, wherein the quaternary ammonium compound or derivative comprises of an active cationic species with a formula of: 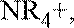
wherein R₄ is selected from the group consisting of an aryl group and an alkyl group.

9. The method of claim 7, wherein the quaternary ammonium compound or derivative comprises an alkoxysilyl quaternary ammonium compound, and wherein the alkoxysilyl quaternary ammonium compound has a formula of: 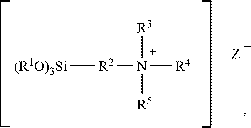
wherein R¹ is selected from the group consisting of a methyl group, an ethyl group, a propyl group, an isopropyl group, a butyl group, and an isobutyl group;
wherein R², R³, R⁴, R⁵ are each independently selected from the group consisting of hydrocarbon moieties having between 1 to 30 carbon atoms, a substituted alkyl group, a unsubstituted alkyl group, a substituted alkenyl group, an unsubstituted alkenyl group, a substituted alkynyl group, an unsubstituted alkynyl group, a substituted aryl group, an unsubstituted aryl group, derivatives thereof, and combinations thereof; and
wherein Z is selected from the group consisting of an anionic atom, an anionic compound, and a halogen.

10. The method of claim 5, wherein the at least the base compound, the at least one bonding agent, and the at least one plasticizer are each independently selected from the group consisting of an alkoxysilane compound, a metal oxide precursor, an alkoxysilane compound and a metal oxide precursor, and combinations thereof.

11. The method of claim 7, wherein the at least one base compound has a formula of M(OR⁶)₄, wherein M is selected from the group consisting of Si, Al, Ti, In, Sn, and Zr, and wherein R⁶ is selected from the group consisting of hydrogen and a substituted or unsubstituted alkyl group or derivative thereof.

12. The method of claim 5, wherein the at least one base compound is tetraethyl orthosilicate (Si(OCH₂CH₃)₄).

13. The method of claim 5, wherein the at least one bonding compound has a formula of: 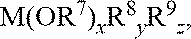
wherein M is selected from the group consisting of Si, Al, In, Sn, and Ti;
wherein R⁷ is selected from the group consisting of hydrogen and a substituted or unsubstituted alkyl group or derivative thereof;
wherein R⁸ is selected from the group consisting of hydrogen and a substituted or unsubstituted alkyl group or derivative thereof;
wherein R⁹ is selected from the group consisting of a substituted or unsubstituted epoxy group and a substituted or unsubstituted glycidoxy group; and
wherein x and z are each independently an integer from 1 to 3, y is an integer from 0 to 2, and the sum of x, y, and z is 4.

14. The method of claim 5, wherein the at least one bonding agent is 3-glycidoxypropyltrimethoxysilane (Si(OCH₃)₃glycidoxy).

15. The method of claim 5, wherein the at least one plasticizer has a formula of: 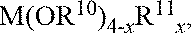
wherein M is selected from the group consisting of Si, Al, In, Sn, and Ti;
wherein R¹⁰ is selected from the group consisting of hydrogen and a substituted or unsubstituted alkyl group or derivative thereof; and
wherein R¹¹ is selected from the group consisting of a substituted or unsubstituted alkyl group, a substituted or unsubstituted alkenyl group, a substituted or unsubstituted alkynyl group, a substituted or unsubstituted aryl group. and derivative thereof; and
wherein x is 1, 2, or 3.

15. The method of claim 5, wherein the at least one plasticizer is trimethoxypropylsilane (Si(OCH₃)₃CH₂CH₂CH₃).

16. The method of claim 5, wherein the coating composition further comprises at least one of a chelating agent, a viscosity modifier, or a functional additive.

17. The method of claim 16, wherein the chelating agent is selected from the group consisting of an alkoxysilane, a metal oxide precursor, and an alkoxysilane and a metal oxide precursor, and wherein the chelating agent has a formula of: 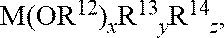
wherein M is selected from the group consisting of Si, Al, In, Sn, and Ti;
wherein R¹² is selected from the group consisting of hydrogen and a substituted or unsubstituted alkyl group or derivative thereof;
wherein R¹³ is selected from the group consisting of hydrogen and a substituted or unsubstituted alkyl group or derivative thereof;
wherein R¹⁴ is selected from the group consisting of a substituted or unsubstituted alky or alkenyl group having from 3 to 20 carbon atoms, a substituted or unsubstituted primary, secondary or tertiary amine, and a thiol; and
wherein x and z are each independently an integer from 1 to 3, y is an integer from 0 to 2, and the sum of x, y, and z is 4.

18. The method of claim 16, wherein the viscosity modifier is an alkoxysilane oligomer having a structure of: 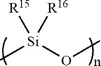
wherein R¹⁵ and R¹⁶ are each independently selected from the group consisting of a same or different functional group, hydrogen, and a substituted or unsubstituted alkyl or derivative thereof.

19. The method of claim 16, wherein the functional additive is capable of chemically reacting with a component selected from the group consisting of the at least one base compound, the at least one bonding agent, the at least one plasticizer, and combination thereof, or is encapsulated within a network of the sol-gel network, and wherein the functional additive is selected from the group consisting of a UV absorbing or blocking compound, an antireflective compound, an anti-abrasion compound, a fire-retardant compound, a conducting compound, and a color imparting compound.

20. The method of claim 5, wherein the coating composition inhibits leaching of the quaternary ammonium compound or derivative from the substrate.
